(19) United States
(12) Patent Application Publication
(10) Pub. No.: US 2012/0111851 A1
(43) Pub. Date: May 10, 2012

(54) Method and Apparatus for Providing a Machine Barrel with a Heater

(76) Inventor: Bruce E. Hyllberg, Gurnee, IL (US)

(21) Appl. No.: 13/383,453

(22) PCT Filed: Jul. 23, 2010
(86) PCT No.: PCT/US10/43062

§ 371 Date: Jan. 11, 2012

Related U.S. Application Data
(60) Provisional application No. 61/230,400, filed on Jul. 31, 2009.

(51) Int. Cl. F27D 11/02; H05B 1/00; B23P 19/04

(52) U.S. Cl. 219/438; 29/592.1

(57) ABSTRACT

A barrel (11a, 11b) adapted for use in a plastics machine, has an inner layer of insulating ceramic (13a, 13b) disposed over and around the barrel along its length to form an insulated barrel, a wire layer (16, 16b) including a plurality of heating coils (17, 17b) of alloy resistance wire wound around the insulated barrel under tension in a spiral fashion, the wire layer also providing additional termination coils (18, 18b) near opposite ends of the barrel for making electrical contact with a source of electrical power to heat the barrel, and a top layer (19, 19b) of an electrically insulating ceramic disposed over the heating coils A method of making a barrel with a heater, comprises spraying a layer (12, 12b) of a metal bonding alloy over a portion of the barrel to be heated.

### CROSS REFERENCE TO RELATED APPLICATION

The benefit of U.S. Provisional Application 61/230,400, filed Jul. 31, 2009, is claimed herein.

### DESCRIPTION OF THE BACKGROUND ART

The present invention is applicable to extruding machines, also referred to as extruders, and material processing apparatus using a cylindrical pipe for the purpose of heating a material or maintaining heat in a material. Extruders are used to process many kinds of materials, but the primary uses are for forming and shaping thermoplastic polymers (plastics) and elastomeric polymers (rubber compounds). Material to be extruded is initially deposited in a solid form into a feedbox. The material exits the extruder as a hot, uniform viscosity, semi-molten solid by being pushed under high pressure (extruded) through a die. The die gives the extruded material (extrudate) its cross sectional shape.

An extruder more particularly includes a barrel, which is a thick-walled steel tube, and a close fitting internal screw, or auger, which is rotated to propel the material down the length of the barrel from an entrance end to an exit end.

To facilitate the extrusion process, the barrel is heated to help soften (rubber) or melt (plastic) the material being extruded. The heating is done in sections or zones which are typically operating at different temperatures. Depending on the properties of the material being extruded, and the requirements of the process, the barrel temperatures of different processes may range from about 200° F. to 650° F., while the temperatures of any individual extruder would vary over a much smaller range. Specialty materials, high melting point engineering plastics, etc, may be processed at temperatures of 750° F. or even higher.

The extrusion process may require a high heat input at the beginning or start up of the process. After steady state conditions have been reached, the barrel heat zones may require both heating and cooling in order to maintain a particular temperature range. Because of this and other reasons, some processes, or barrel sections, require both heating and cooling, while others require only heating. The intention of this disclosure is to address primarily a more effective means to meeting the heating requirements of the various barrel heat zones.

Typical extruder barrel sizes range from about 1.5 inches to 17 inches in outside diameter with heated zone lengths of 5 to 18 inches or more. The zone lengths vary with the diameter of the barrel and are typically one to three times the barrel diameter with the relatively shorter zones on the larger diameter barrels.

A barrel is normally divided into a number of heated zones which may number up to eight or more for a single barrel. The barrel is divided into relatively short heat zones for two reasons. The first is to provide process control that will allow different temperatures at different points in the extrusion process. The second is a practical matter that relates to the types of heaters and performance limitations that are currently used for barrel heating, and to limit the replacement cost of an individual zone heater.

The types of heaters used for extruder barrels, which are attached externally, have included band heaters, cast-in-aluminum shell heaters and induction heaters.

The band heater is typically a cylindrical heater made of resistance wire which is split in at least one place to allow fitting around the barrel. The band heater contains various layers of insulation (mica or ceramic) around the heater wires and an outer sheath of metal or stainless steel. The band heater is fixed to the extruder barrel with one or more tight fitting clamps or bands. Because the contact of the heater to the barrel surface is imperfect, basically only a few line contacts, the heat transfer from the band heater is relatively inefficient causing temperature excursions inside the band heater. The temperature on the inside diameter of the barrel can vary by 20% (100° F. at 500° F. for example) from the target temperature. The parts of the heater not in actual contact with the barrel can overheat and burn out under high thermal loads. For processes that do not require cooling, insulation cannot normally be used over a band heater, because it promotes overheating in low heat transfer areas of the heater. The cost of the band heater is based on watt density, operating temperature, and barrel size. Some of the larger units can be quite expensive. For cooling of the heated sections, the band heaters are fitted with shrouds having forced air cooling. The poor thermal contact of the band heater to the barrel also affects the cooling rate.

The cast-In aluminum shell heater, also known as a cast-in band heater, employs one or more tube heaters (a metal tube packed with ceramic powder, with a heater wire down the center) as the heater elements. A tube heater is very robust and is used for stove top burners and oven heaters in stoves and can operate red hot without failure. The cast-in aluminum shell heater, such as those made by Tempco Electric Heater Corporation, Wood Dale, Ill., is a cylinder of thick cast aluminum which is split in half along the center axis. The halves of the aluminum shells are bolted or banded together around the extruder barrel. The aluminum shells are cast around the folded tube heater so that the heat transfer from the tube heater to the aluminum shell is complete and uniform. Some types also have embedded tubes for liquid cooling which are cast into the aluminum as well. Others have cooling fins and are used with conventional forced air cooling units for extruder barrels. The thermal contact of the aluminum shells to the extruder barrel is composed of a series on line contacts and is therefore not as efficient as desired for heating or cooling. The aluminum shells also have considerable thermal mass when attempting to heat or cool a barrel section. They are also quite expensive although durable.

A zone heater which uses induction heating to heat the extruder barrel has been commercially offered by, Xaloy Inc. New Castle, Pa. It is efficient, produces much more uniform temperatures than band heaters, but is quite expensive. Thermal coupling to the barrel is excellent. It is currently only used in applications that do not require cooling, since a cost effective way to cool an induction heated zone has not been devised.

The existing heater technologies for extruder barrels that are either bolted, banded, or clamped to the outside surface of the extruder barrel may have these limitations:
1) Limited heater to barrel contact and therefore limited heat transfer rates, heating or cooling;
2) Significant non-uniformity in temperature at the internal diameter of the extruder barrel where the material is processed;
3) Reduced heater life due to burn out caused by non-uniform heat transfer;
4) High thermal mass and a resulting slow temperature response time, heating and cooling;
5) High heated zone cost; and
6) Inability to cool heated zones.

It would be advantageous if a thinner, higher heat transfer, heater layer can be used as a barrel heater to overcome many of the problems of other externally attached heaters, such as limited or non-uniform heat transfer, heater burn-out, temperature non-uniformity, high thermal mass and slow response time to heating or cooling, and the inability to effective cool the heated zones.

The advantage of thermally sprayed heater layers on the extruder barrel, is that the effective thermal contact area is uniform and close to 100% providing excellent thermal contact for heating or cooling. This type of heater is described in U.S. Pat. Nos. 5,616,263 and 5,869,808, and particularly U.S. Pat. No. 6,285,006 where a thinner combination of layers is used to facilitate higher temperatures. The layers comprising the heater will always be the same temperature as the barrel within a few degrees. The possibility of the heater burning out due to locally high temperature or poor heat transfer is remote. Temperature uniformity will be excellent as long as the thickness and resistance of the heater layer is uniform. The combination coating, composed of the insulating and heaters layers, is very thin (typically less than 30 mils), extremely low in mass, and relatively high in thermal conductivity. Air cooling on the outside of the combination coating by conventional forced air barrel coolers would be much more effective than over other types of heaters. The combination ceramic coating would not perform like a thermal insulator.

Nevertheless, the thermally sprayed ceramic heater technology has some limitations which are disadvantageous as a barrel heater:
1) Thermal expansion differences between the ceramic layers and the steel barrel may cause cracking or resistance changes in the heater layer especially above 500° F.
2) A ceramic heater is a negative coefficient material and radically drops in resistance as the temperature is increased. This also means the heater is a slow starter, having lower power at start up than later on.
3) The ceramic heater has a high contact resistance, partly due to the textured plasma as-sprayed surface, which tends to arc and fail if the contact area or contact force of the power source electrode is not sufficiently large or uniform.
4) The resistance of the heater layer is typically non-linear with respect to thickness increasing the difficulty in producing heater layers of consistent resistance on identical parts.
5) The electrically conductive portion of the titania coating (TiO suboxide) can recombine with oxygen at higher temperatures (becoming non-conductive TiO2) increasing the resistance of the heater layer, usually in a non-uniform manner.

### SUMMARY OF THE INVENTION

The invention provides a barrel adapted for use in a machine, the barrel having a heater for energization to heat a material within the machine, the barrel further comprising an inner layer of insulating ceramic disposed over and around the barrel along its length to form an insulated barrel; a wire layer including a plurality of heating coils of alloy resistance wire wound around the insulated barrel under tension in a spiral fashion; the wire layer also providing additional termination coils near opposite ends of the barrel for making electrical contact with a source of electrical power to heat the barrel; and a top layer of an electrically insulating ceramic disposed over the heating coils to improve the thermal contact of the wire to the inner ceramic layer and to help maintain the proper wire spacing between the coils.

The invention also provides a method of making a barrel with a heater, the barrel being adapted for energization to heat a material within a machine, the method comprising spraying a layer of a metal bonding alloy over a portion of the barrel to be heated, whereupon the layer solidifies; thereafter, spraying an inner layer of electrically insulating ceramic, selected from alumina, zirconia or mixtures including alumina or zirconia, over the metal bond layer to form an insulated portion of the barrel with an electrically insulating ceramic layer; thereafter, winding a length of resistance wire around the insulated portion of the barrel under tension to form a wire layer in a heater zone and in termination zones on opposite ends of the heater zone; and thereafter, spraying a top layer of insulating ceramic, selected from alumina, zirconia or mixtures including alumina or zirconia, over the heater zone of the wire layer, while leaving the termination zones exposed.

In a further aspect of the invention the top layer can be made to a thickness in a range from 20-25 mils thick. In a further aspect of the invention the wire layer and the inner ceramic layer can also be made to a thickness of 20-25 mils thick, the same as the top ceramic layer.

In a further aspect of the invention, the heater is used to melt plastic material in an extruder. The invention can also be applied to rubber processing machines, and to apparatus used in the food and chemical processing industries.

The invention overcomes the performance limitations of the barrel heater types previously discussed, while retaining the high heat transfer rates (heating and cooling) and the uniform temperatures of the plasma-sprayed ceramic heater technology.

### BRIEF DESCRIPTION OF THE DRAWINGS

FIG. 1 is a sectional view of a portion of a barrel in an extruder machine illustrating extruder barrel with a prior art plasma sprayed ceramic heater layer applied on the barrel;

FIG. 2 is a sectional view of a portion of a barrel in an extruder machine having a wound wire heater on an extruder barrel;

FIG. 3 is a side view in elevation of the insulated barrel after application of the heater layer; and

FIG. 4 is a sectional view of a portion of a barrel in an extruder machine showing a thicker ceramic layer for covering the wire portion of the extruder barrel.

### DETAILED DESCRIPTION OF THE PREFERRED EMBODIMENTS

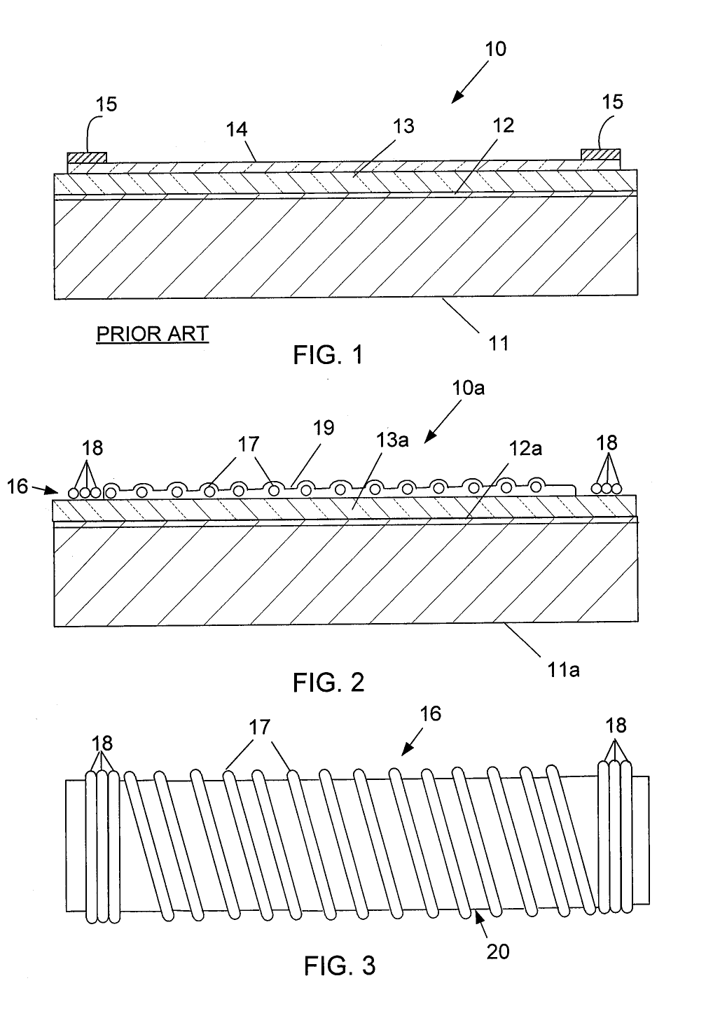

As seen in FIG. 1, in a first embodiment of a barrel heater 10, an extruder barrel 11 of mild steel, to which the heater sections will be applied, is first grit blasted to a 250 microinch Rₐ finish or higher. Extruders are used to process many kinds of materials, but the primary uses are for forming and shaping thermoplastic polymers (plastics) and elastomeric polymers (rubber compounds). Material to be extruded is initially deposited in a solid form into a feedbox. The material exits the extruder as a hot, uniform viscosity, semi-molten solid by being pushed under high pressure (extruded) through a die. The die gives the extruded material (extrudate) its cross sectional shape. Next, in forming the barrel, a thin layer of a metal bonding alloy 12 is plasma or thermal sprayed over the entire barrel (covering all heated zones) such as Sulzer Metco 450 or 480 nickel aluminide bond coat in a thickness of 3-5 mils. Areas of the barrel may need to be masked to prevent adhesion of the bonding alloy such as holes for thermocouples or for bracket attachments.

A layer of ceramic insulator 13 is applied over the metal bond layer 12 such as alumina or zirconia or blends of both. Aluminum oxides such as Sulzer Metco 101 or 105 can be used as well as stabilized zirconium oxides such as Sulzer Metco 204. The thickness of the ceramic layer 13 is determined by the heater voltage that will be used and the operating temperature. The thickness of the ceramic insulator 13 will be in the to 40 mil thick range with a typical thickness of 20 mils. Zirconia would tend to be used on higher temperature applications as the thermal expansion rate is somewhat closer to mild steel and the material can tolerate greater thermal shock without cracking. Areas of the barrel may need to be masked to prevent adhesion of the ceramic such as holes for thermocouples or for bracket attachments.

A ceramic heater layer 14 is then formed over the insulator layer 14 as described in U.S. Pat. No. 6,285,006. The heater layer is typically plasma sprayed titanium dioxide (titania). This material is normally an electrical insulator but is partially reduced to titanium (mono) oxide during plasma spraying, which is a semi-conductor. The final layer is typically 80% titanium dioxide and 20% titanium oxide. Titania can also be blended with insulating ceramics, such as alumina, or conductive metal or alloys to make adjustments in the resistance of the sprayed heater layer. The heater layer is normally a continuous layer or cylinder (single resistor) but could be applied as individual stripes with narrow gaps between stripes (resistors in parallel) with little effect on the total resistance. This striped method is described in U.S. Pat. No. 6,596,960. An optional top layer of ceramic insulator (not shown) can then be applied. Usually, thin metal bands 15 are also sprayed on the ends of the heater layer to promote lower contact resistance to the electrode contact from the power supply and prevent arcing.

As seen in FIG. 2, in the heater 10a of the present invention, the method, as described for FIG. 1, can be used to adhere a ceramic insulator layer 13a to an extruder barrel 11a of mild steel or other commonly used extruder barrel alloys using a metal bond layer 12a. As seen in FIG. 3, instead of a ceramic heater layer, a layer of resistance wire 16 is wound around the insulated barrel 20 under tension to form a heated zone. The length of wire 16 is calculated from the resistance known to provide the required wattage at the voltage applied. One length of wire can be used to form a single resistor heater or multiple wires of equal lengths can be used to form a heater with resistances in parallel.

The first few coils 17 are termination coils of resistance wire 16 that are wound circumferentially and are closely positioned right next to each other, and are in contact, to form an electrode 18 in a termination zone. These coils and are not included as part of the heater length. The combined resistance of the coils 17 that are touching form an electrode that is much lower than the resistance of a single wire and thus provide minimal heating with current. These coils are soldered, brazed, or tack welded together to form an electrode ring 18 and to prevent the heater wire 17 from uncoiling. Electrode rings 18 are formed on each end of the heat zone for single phase power supplies or at multiple equally spaced locations for three phase power supplies.

The heater coils 17 normally have a pitch angle so as to be wound diagonally around the insulated barrel 20. When viewed in section, these heater coils are approximately equally spaced in a longitudinal direction along the barrel 20, although there may be discontinuities in the barrel surface for mounting thermocouples, brackets, or other devices. In this case, the wire spacing may not be uniform in these areas which will have some minor effects on the overall uniformity of the barrel temperature.

If a top layer of insulating ceramic 19 (FIG. 2) is to be used, the wire layer 16 may need to be grit blasted to promote adhesion. This can be accomplished just prior to the wire being wound on the barrel or after the entire wire layer is formed. If the wire is grit blasted after the wire layer is formed, care needs to be taken to prevent excessive removal of the ceramic base layer 13a. Additional insulating ceramic could be sprayed initially to account for the loss during this step. A thin top layer of ceramic will serve to maintain the spaces between the wire coils, will improve heat transfer to the extruder barrel, and will provide insulation for protection from powered wire coils. A thicker layer of ceramic can also be provided so that the top layer of ceramic can be ground to a smooth and uniform finish. In this case, the ceramic would need to be at least 10 mils thicker than the wire, after grinding, but typically equal to the wire thickness above the tops of the wires after grinding.

A top insulating layer 19 of either alumina or zirconia (or blends of both) is then plasma-sprayed over the base layer of insulator 13a and the heater wire layer 17. Areas of the electrode rings 18 will need to be masked to prevent adhesion of the ceramic where the power supply electrodes will contact the heater layer ring electrodes. For a simple interface to the power supply, hose clamps can be used over the electrode rings to provide an external electrode for the connection of power wires. Other areas of the barrel 20 may also need to be masked such as holes for thermocouples and areas for bracket attachments. This completes the fabrication of the proposed heater layer. An electrical connection can be made to wire electrodes 18 using a hose clamp of a type known in the art, to an extruder barrel 11a of mild steel or other commonly used extruder barrel alloys.

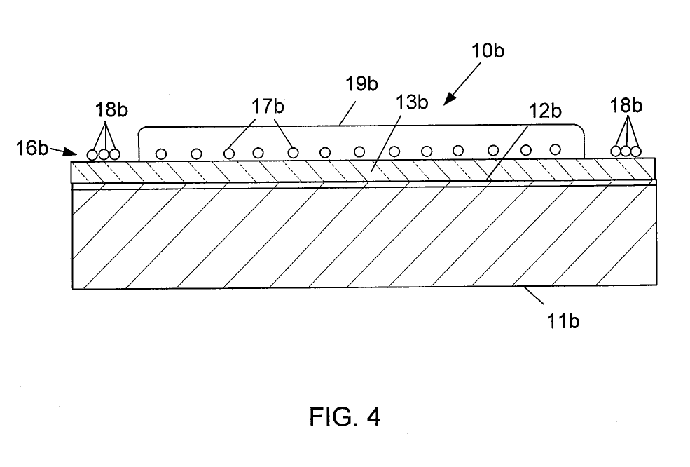

FIG. 4 illustrates a second embodiment of the invention in which the top ceramic layer 19b has been expanded to be a relatively thick layer which is ground (although it does not have to be ground to be functional) to provide a smooth surface and a uniform thickness using a diamond-coated or other suitable grinding wheel. The thickness of the layer 19b above the tops of the wires 17b is about the same thickness as the wires 17b after the layer has been ground to provide a smooth surface. Layers 13b, 16b, and 19b above the wires 17b, could all be 20-25 mils thick each, for example. The thick top ceramic layer 19b improves heat transfer from the wires 17b into the barrel 11b, makes a more durable composite layer which will withstand abuse and impacts, provides electrical insulation over the current-carrying heater wires 17b, and provides a smooth surface on which to apply a conventional band heater in the event that the ceramic-wire heater fails or is damaged in some way. The extruder barrel 11b is again made of mild steel or other commonly used extruder barrel alloys and a metal bond layer 12b is formed, as described above before adding the ceramic layer 13b as described above, to an extruder barrel 11a of mild steel or other commonly used extruder barrel alloys.

Resistance wire alloys, typically containing nickel and chromium, or in combination with iron and other metals, are used in a wide variety of resistance heaters: tube heaters, cartridge heaters, immersion heaters, space or air heaters, to name a few. Resistance wire is available in various alloys in a large number of standard wire sizes from at least #4 (0.204 inches diameter) to #40 (0.0018 inches diameter) and non-standard sizes down to 0.0005 inches in diameter. Each resistance wire alloy has a specific resistance value per foot related to the cross-sectional area of the wire, usually specified to at least three significant digits, and is widely available. Resistance wire can operate at high temperatures. Nickel (80%) and chromium (20%) wire, for example, can operate successfully up to temperatures of around 1800° F.

Resistance wire is also a PTC or positive temperature coefficient material as its resistance increases somewhat with temperature. Its resistance increases less than 10 percent from room temperature to 500° F. providing a heater with stable amperage over a large temperature range. This feature provides maximum heat generation at the beginning of the heating cycle and yet somewhat limits the maximum current at very high temperatures. A common example is a toaster oven that uses tube heaters made of resistance wire. The current draw at the beginning of the heating cycle is higher than later on when the heating elements are red hot.

TABLE 1
ELECTRICAL RESISTIVITY OF CERTAIN METALS
AND RESISTANCE ALLOYS:

| | Resistivity |
|---|---|
| | (ohm/foot/ |
| Alloy | circular mil) |
| Copper 99.9% | 10 |
| 6061 Aluminum | 23 |
| Mild Carbon Steel | 60 |
| 80 Nickel 20 Chromium | 650 |
| 60 Nickel 15 Chromium 25 Iron | 675 |
| 35 Nickel 20 Chromium 45 Iron | 610 |
| 74 Nickel 20 Chromium 3 Aluminum 3 Iron | 800 |

Using resistance wire, a heater is designed to be used at a specific voltage, amperage, and wattage. For example, a 1000 watt heater operating at 110 volts would require a current of 9.09 amperes according to Ohm's Law (1000/110=9.09). That would yield a heater resistance of (110/9.09=12.1) 12.1 ohms. Using a #20 gauge wire from Table 2 would require a wire length of 18.4 feet of wire to provide 12.1 ohms (12.1/0.659=18.4).

If this 1000 watt heater is wound around a hypothetical barrel of 3.82 inches diameter (12.0 inches circumference), the heater would consist of 18.4 coils equally spaced. On a 9.75 inch length heated zone, this would amount to approximately 0.5 inch spaces between wire coils of 0.032 inches diameter. With 110 volts equally divided over 18.4 coils of wire (17+ spaces), the voltage between adjacent coils is only on the order of 6.5 volts.

TABLE 2
Resistance Heater Wire
60% Nickel 16% Chromium 24% Iron
Temp. to 3056° F. (1680° C.)

| Wire Size | Wire Diameter | Resistance |
|---|---|---|
| (No.) | (Inches) | (Ohms per Foot) |
| 18 AWG | 0.040 | 0.422 |
| 20 AWG | 0.032 | 0.659 |
| 22 AWG | 0.025 | 1.055 |
| 24 AWG | 0.020 | 1.671 |
| 26 AWG | 0.014 | 2.670 |

The various components of the heater (ceramic insulator, wire heater, top insulator) all have different thermal expansion rates than the barrel itself.

TABLE 3
THERMAL EXPANSION RATES OF MATERIALS

| | Micro-inches/ |
|---|---|
| Material | inch/deg F |
| Mild Carbon Steel | 6.7 |
| Alumina | 4.5 |
| Zirconia | 5.7 |
| Heater Wire (Typical) | 8.5 |

In order to prevent the wire loops from loosening during plasma spraying of the optional top layer of ceramic insulator, or during heater operation, the wire is wound over the ceramic insulator under significant tension but below the yield point of the wire. This tension serves to offset the thermal expansion in the wire, which is higher than the barrel over which it is wound, and to maintain uniform wire contact to the ceramic insulator layer over a wide temperature range. With a thick top ceramic layer, the wire is held in place by the ceramic and tension in the wire is no longer required to maintain contact to the lower ceramic layer.

By winding a layer of resistance heater wire over a plasma sprayed ceramic insulator, the following advantages can be realized compared to the prior art technologies:
1) Capable of much higher operating temperatures (at least 400° F. higher), and watt densities (at least 4 times higher), compared to a ceramic heater layer and much better thermal stress resistance;
2) Full power is available at the beginning of the heating cycle and amperage is nearly constant over a wide temperature range;
3) Much more robust and failure resistant—longer heater life due to excellent and uniform thermal contact;
4) Very repeatable heater resistance, amperage, and wattage based on wire size and length;
5) Predictable watt density based on total heater wattage and wire spacing;
6) Uniform thermal contact of the heater wire to the ceramic insulator and barrel;
7) No concern of damaging the heater due to thermal expansion or oxidation or of permanent resistance changes in the heater;
8) Excellent thermal contact to the barrel and low thermal mass for heating or cooling; and
9) Non-critical electrode contact area and contact pressure.

It will be apparent to those of ordinary skill in the art that other modifications might be made to these embodiments without departing from the spirit and scope of the invention.

I claim:

1. A barrel adapted for heating a material within a machine, the barrel having a heater for energization to melt the material, the barrel further comprising:
an inner layer of insulating ceramic disposed over and around the barrel along its length to form an electrically insulated barrel;
a wire layer including a plurality of heating coils of alloy resistance wire wound around the insulated barrel under tension in a spiral fashion;
the wire layer also providing additional termination coils near opposite ends of the barrel for making electrical contact with a source of electrical power to heat the barrel; and
a top layer of an insulating ceramic disposed over the heating coils to improve the thermal contact of the wire to the inner ceramic layer and to help maintain the proper wire spacing between the coils.

2. The barrel as recited in claim 1, wherein with the heating coils are equally spaced to provide temperature uniformity and to prevent short circuits.

3. The barrel as recited in claim 1, wherein the top layer has a thickness in a radial direction relative to the barrel in a range from 20-25 mils above the wire layer.

4. The barrel as recited in claim 3, wherein the wire layer has a thickness in a radial direction relative to the barrel in a range from 20 to 25 mils.

5. The barrel as recited in claim 4, wherein the inner layer of insulating ceramic has a thickness in a radial direction relative to the barrel in a range from 20 to 25 mils.

6. The barrel as recited in claim 1, wherein the wire size is selected from a range from 18 gauge to 26 gauge.

7. The barrel as recited in claim 1, wherein the top layer has been ground to provide a smooth surface.

8. The barrel as recited in claim 1, wherein the termination coils are wound circumferentially and are closely positioned right next to each other, and are in contact, to form electrodes at opposite ends of the heating layer.

9. The barrel as recited in claim 8, wherein the termination coils on opposite ends of the heating layer are soldered, brazed, or tack welded together to form electrode rings.

10. The barrel as recited in claim 1, wherein the material that is heated is at least one of a solid plastics material and a solid rubber material that is heated to a melt or softening temperature.

11. A method of making a barrel with a heater, the barrel being adapted for energization to heat a solid within a machine, the method comprising:
spraying a layer of a metal bonding alloy over a portion of the barrel to be heated whereupon the layer solidifies;
thereafter, spraying an inner layer of electrically insulating ceramic, selected from alumina, zirconia or mixtures including alumina or zirconia, over the metal bond layer to form an electrically insulated portion of the barrel with an electrically insulating ceramic layer in a thickness from 10 to 40 mil thick;
thereafter, winding a length of resistance wire around the insulated portion of barrel under tension to form a wire layer in a heater zone and in termination zones on opposite ends of the heater zone; and
thereafter, spraying a top layer of insulating ceramic, selected from alumina, zirconia or mixtures including alumina or zirconia, over the heater zone of the wire layer in a thickness from 10 to 40 mil thick, while leaving the termination zones exposed.

12. The method as recited in claim 11, further comprising prior to spraying the top layer of insulating ceramic; grit blasting the wire layer to promote adhesion of the top layer of insulating ceramic.

13. The method as recited in claim 12, wherein after grit blasting, additional insulating ceramic is sprayed to increase the thickness of the inner ceramic layer to a thickness present before the grit blasting operation.

14. The method as recited in claim 11, wherein with the wire layer in the heater zone is wound with heating coils at equidistant spacing to provide temperature uniformity and to prevent short circuits.

15. The method as recited in claim 11, wherein the top layer is sprayed to a thickness in a radial direction relative to the barrel in a range from 20-25 mils above the wire layer.

16. The method as recited in claim 15, wherein the wire layer is formed with a thickness in a radial direction relative to the barrel in a range from 20 to 25 mils.

17. The method as recited in claim 16, wherein the inner layer of insulating ceramic is sprayed to a thickness in a radial direction relative to the barrel in a range from 20 to 25 mils.

18. The method as recited in claim 11, wherein the wire size is selected from a range from 18 gauge to 26 gauge.

19. The method as recited in claim 11, wherein the wire layer in the termination zones includes termination coils that are wound circumferentially and are closely positioned right next to each other, and are in contact, to form electrodes at opposite ends of the heating zone.

20. The method as recited in claim 19, wherein the termination coils on opposite ends of the heater zone are soldered, brazed, or tack welded together to form electrode rings.

21. The method of claim 11, wherein the material that is heated is at least one of a solid plastics material or a solid rubber material that is heated to a melt or softening temperature.
